(19) United States
(12) Patent Application Publication
(10) Pub. No.: US 2005/0019033 A1
(43) Pub. Date: Jan. 27, 2005

(54) Method and apparatus for controlling downstream traffic in ethernet passive optical network

(76) Inventors: Ho-Il Oh, Seoul (KR); Su-Hyung Kim, Seoul (KR); Min-Hyo Lee, Suwon-shi (KR); Young-Seok Kim, Songnam-shi (KR); Yun-Je Oh, Yongin-shi (KR); Tae-Sung Park, Yongin-shi (KR); Kye-Hyun Ahn, Taejonkwangyok-shi (KR); Dong-Kook Kang, Jeonju-shi (KR); Hyuk-Kyu Park, Jeonju-shi (KR); Choong-Kun Cho, Jeonju-shi (KR); Young-Chon Kim, Jeonju-shi (KR)

Correspondence Address: CHA & REITER, LLC, 210 ROUTE 4 EAST STE 103, PARAMUS, NJ, 07652, US

(21) Appl. No.: 10/695,079

(22) Filed: Oct. 28, 2003

(30) Foreign Application Priority Data
Jul. 23, 2003 (KR) 2003-50768

(51) Int. Cl. H04B 10/20

(52) U.S. Cl. 398/58

(57) ABSTRACT

Disclosed is a method and apparatus for controlling downstream traffic in an EPON (Ethernet Passive Optical Network). Individual tokens respectively for ONUs (Optical Network Units) are generated and stored, and a common token based on a total transfer rate of the EPON is generated and stored. In order to transmit downstream data, it is determined whether the downstream data is transmittable first by the corresponding individual token, and then second by the common token if the first determination is negative. In the case where traffic is concentrated on an ONU at a time, even if downstream data cannot be transmitted by an individual token for the corresponding ONU, the common token not used by other ONUs can be used to transmit the downstream data. It is thus possible to guarantee minimum/maximum transfer rates to all ONUs and ensure QoS against burst traffic in the EPON.

### CLAIM OF PRIORITY

This application claims priority to an application entitled “METHOD AND APPARATUS FOR CONTROLLING DOWNSTREAM TRAFFIC IN ETHERNET PASSIVE OPTICAL NETWORK,” filed in the Korean Intellectual Property Office on Jul. 23, 2003 and assigned Serial No. 2003-50768, the contents of which are hereby incorporated by reference.

### BACKGROUND OF THE INVENTION

1. Field of the Invention

The present invention relates to a PON (Passive Optical Network), and more particularly, to a method and apparatus for controlling downstream traffic using tokens in an EPON (Ethernet Passive Optical Network).

2. Description of the Related Art

Recently, there have been proposed various kinds of network structures and evolution strategies for implementing a subscriber network extending from a central telephone office to a building or home. Some examples are xDSL (x-Digital Subscriber Line), HFC (Hybrid Fiber Coax), FTTB (Fiber To The Building), FTTH (Fiber To The Home), etc. Among them, the FTTxs (x=B, C or H) are classified into an active FTTx implemented with an AON (Active Optical Network) architecture and a passive FTTx implemented with a PON architecture. Being employed in implementing the passive FTTx, the PON has been suggested as a potential solution for implementing an economical optical network. This is because it has a network architecture with a point-to-multipoint topology employing a passive element. In other words, the PON uses a 1×N ODN (Optical Distribution Network) to provide connections between a single OLT (Optical Line Termination) and a number of ONUs (Optical Network Units), so as to form a tree-structured distribution topology.

Among the PON types, an ATM-PON (Asynchronous Transfer Mode Passive Optical Network) was first developed and standardized, and its details have been described in ITU-T G.982, ITU-T G.983.1 and ITU-T G.983.3, which were documented in the ITU-T (International Telecommunication Union—Telecommunication section). Further, the standardization of a GE-PON (Gigabit Ethernet-PON) system is underway at IEEE 802.3ah TF in the IEEE (Institute of Electrical and Electronics Engineers).

Meanwhile, MAC (Medium Access Control) technologies for the ATM-PON and a GE-PON having a point-to-point scheme have already been standardized. The contents thereof have been described in IEEE 802.3z and ITU-T G.983.1. In addition, U.S. Pat. No. 5,973,374 issued on Nov. 2, 1999, entitled “PROTOCOL FOR DATA COMMUNICATION OVER A POINT-TO-MULTIPOINT PASSIVE OPTICAL NETWORK” has disclosed details of the MAC technologies in the ATM-PON.

FIG. 1 is a block diagram showing an example of a conventional PON. A PON generally includes a single OLT and a number of ONUs. The PON illustrated in this drawing is an example in which a single OLT 10 is connected to three ONUs 12a, 12b and 12c through an ODN 16. As shown in FIG. 1, the OLT 10 is positioned at the root of a tree structure and plays a primary role in providing information to each subscriber in an access network. Being connected to the OLT 10, the ODN 16 with a tree topology structure distributes downstream data frames from the OLT 10 to the ONUs 12a to 12c. Further, the ODN 16 multiplexes upstream data frames from the ONUs 12a to 12c and transmits them to the OLT 10. The ONUs 12a to 12c receive the downstream data frames and provide them to end users 14a, 14b and 14c, and transmit output data from the end users 14a to 14c, as upstream data frames, to the OLT 10 through the ODN 16. The end users 14a to 14c, connected respectively to the ONUs 12a to 12c, represent various kinds of network terminal devices, including an NT (Network Terminal), usable in the PON.

In the ATM-PON, upstream and downstream transmission is generally performed using frames each including 53-byte ATM cells combined into a predetermined size. In the tree PON architecture as shown in FIG. 1, the OLT 10 inserts downstream cells to be distributed to each ONU 12a to 12c into a downstream frame. For upstream transmission, the OLT 10 employs a TDM (Time Division Multiplexing) scheme to gain access to data transmitted from the ONUs 12a to 12c. Since the ODN 16 connected between the OLT 10 and the ONUs 12a to 12c is a passive element, the OLT 10 employs a pseudo-range correction algorithm, called “ranging”, to avoid data collision in the ODN 16.

A PON based particularly on Ethernet is called an EPON (Ethernet Passive Optical Network). In the EPON, the TDM scheme is employed for upstream traffic transmission as mentioned above with the PON. However, no special control is performed on a downstream data frame when it is transmitted from a backbone network to the subscriber network. This may cause a fairness problem (for example, unfair network-resource distribution) in the ONUs. Particularly when burst traffic occurs to be transmitted to an ONU, traffic for other ONUs may be delayed or lost, thereby failing to guarantee QoS. The control of downstream traffic is thus essential for the EPON to enable the monitoring and control of subscribers' contracted bandwidth, the control of fairness among ONUs, the efficient utilization of network resources and the guarantee of QoS against burst traffic, etc.

### SUMMARY OF THE INVENTION

Therefore, the present invention has been made in view of the above problems, and it is an object of the present invention to provide a method and apparatus for controlling downstream traffic in an EPON so as to enable the monitoring and control of subscribers' contracted bandwidth in the EPON.

It is another object of the present invention to provide a method and apparatus for controlling downstream traffic in the EPON so as to guarantee a contracted bandwidth for each ONU and thus enable the control of fairness between ONUs in the EPON.

It is a further object of the present invention to provide a method and apparatus for controlling downstream traffic in the EPON so as to enable efficient network-resource utilization in the EPON.

It is still another object of the present invention to provide a method and apparatus for controlling downstream traffic in the EPON so as to enable the guarantee of QoS against burst traffic in the EPON.

It is yet another object of the present invention to provide a method and apparatus for controlling downstream traffic in the EPON, wherein a minimum guaranteed bandwidth is given to each ONU, and the remaining unused bandwidth, other than the minimum guaranteed bandwidth, is allowed to be used by other ONUs, thereby achieving a more effective downstream traffic control in the EPON.

In accordance with one aspect of the present invention, the above and other objects can be accomplished by the provision of a method for controlling traffic of downstream data to be transmitted from an OLT (Optical Line Termination) to ONUs (Optical Network Units) in an EPON (Ethernet Passive Optical Network) including an ODN (Optical Distribution Network) connected to the OLT and a plurality of the ONUs connected to a plurality of subscribers. The method includes generating individual tokens respectively for the ONUs based on individual transfer rates allocated respectively to the ONUs, and then storing the individual tokens while classifying them according to the ONUs; generating a common token based on a total transfer rate of the EPON, and then storing the common token. When downstream data occurs, classifying the downstream data based on information of the data's destination ONU, and then storing it in a corresponding one of transmission buffers which correspond respectively to the ONUs; selecting one of the transmission buffers and checking whether there is downstream data awaiting transmission stored in the selected buffer; and determining whether the downstream data can be transmitted based on individual token information, previously stored, for an ONU corresponding to the downstream data. If it is determined that the downstream data cannot be transmitted based on the individual token information, determining whether the downstream data can be transmitted based on information of the common tokens. If it is determined that the downstream data can be transmitted based on the common token information, transmitting the downstream data, and changing the common token information according to the transmission result;calculating a service rate of the corresponding ONU according to the transmission result; and storing the calculated service rate.

In accordance with another aspect of the present invention, there is provided an apparatus for controlling traffic of downstream data to be transmitted from an OLT (Optical Line Termination) to ONUs (Optical Network Units) in an EPON (Ethernet Passive Optical Network) including an ODN (Optical Distribution Network) connected to the OLT and a plurality of the ONUs connected to a plurality of subscribers. The apparatus including a common token information manager for managing common token information according to a total transfer rate of the EPON; a packet classifier for classifying downstream data according to its destination ONU; a first packet processor for determining whether downstream data can be transmitted based on the common token information and individual token information previously store for an ONU corresponding to the downstream data. The first packet processor including elements corresponding respectively to the ONUs; a packet transmitter for receiving downstream data to be transmitted to each of the ONUs from the first packet processor, converting the downstream data into an EPON frame, and then multiplexing and outputting it after attaching address information of the corresponding ONU to it; a second packet processor for temporarily storing a downstream data signal outputted from the packet transmitter, and transmitting it to a corresponding ONU through a downstream link connected to the corresponding ONU, and then, after changing the common token information based on the transmission result, transferring the changed result to the common token information manager.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing an example of a conventional PON;

FIGS. 2a to 2c are flowcharts illustrating a method for controlling downstream traffic in an EPON according to one embodiment of the present invention;

FIG. 3 is a block diagram showing an EPON according to one embodiment of the present invention;

FIG. 4 is a schematic block diagram showing a downstream traffic controller according to one embodiment of the present invention;

FIG. 5 is a schematic block diagram showing a first packet processor according to one embodiment of the present invention; and

FIG. 6 is a schematic block diagram showing a second packet processor according to one embodiment of the present invention.

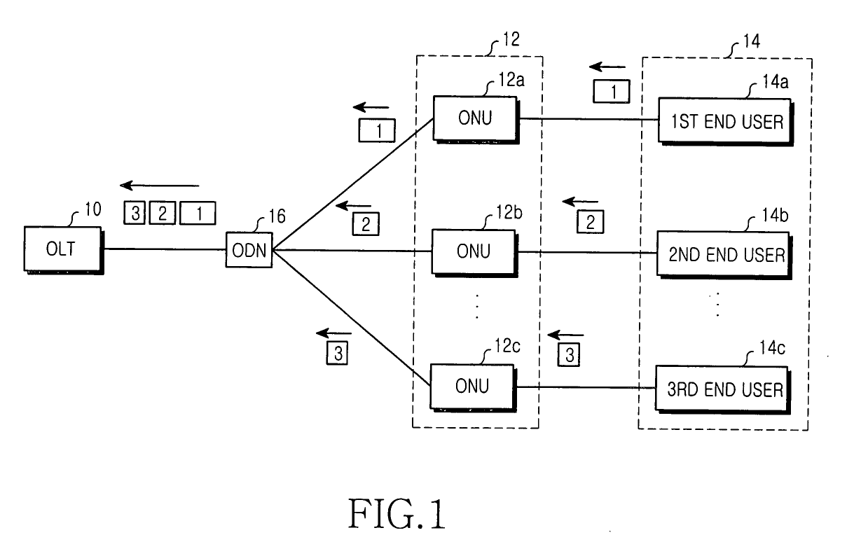

### DETAILED DESCRIPTION OF THE PREFERRED EMBODIMENTS

Now, preferred embodiments of the present invention will be described in detail with reference to the annexed drawings. In the following description, a detailed description of known functions and configurations incorporated herein will be omitted when it makes the subject matter of the present invention rather unclear.

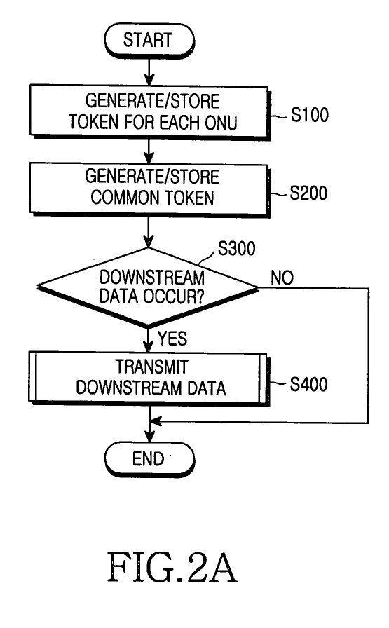

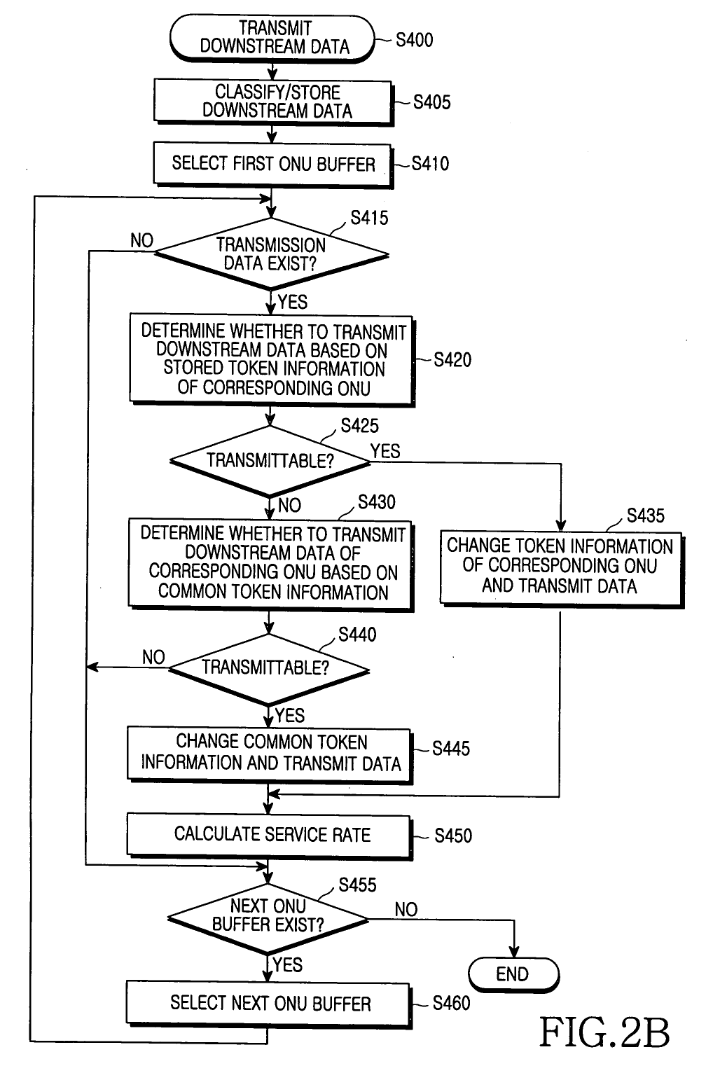

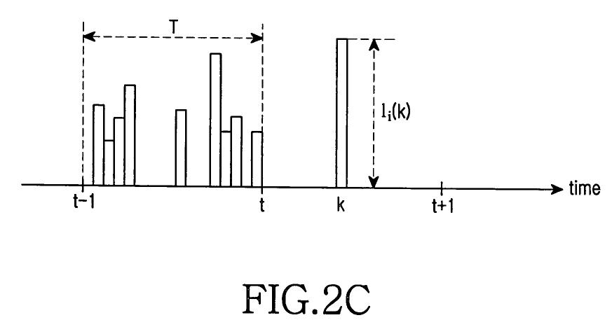

FIGS. 2a and 2b are flowcharts showing a method for controlling downstream traffic in an EPON according to one embodiment of the present invention.

As shown in FIG. 2a, individual tokens for each ONU and common tokens are generated and stored (S100, S200). The individual tokens for each ONU are tokens allocated individually to each of the ONUs, and the common tokens are tokens allocated to a network corresponding to the ONUs (for example, an EPON (Ethernet Passive Optical Network)). It is preferable to perform the processes of steps S100 and S200 in an OLT. The term “token” refers to a series of special bits that circulate on a token-ring network. Computers can send a message to the network only when they catch the token circulating on the network. There is only one token for each token-ring network, which prevents two or more computers from sending messages simultaneously. In this way, the token is used as a kind of “license” to transmit data of a specific length (for example, 1 Byte) on the network.

Generally, ONUs establish a contract on resource allocation according to traffic characteristics. Then, an ONUᵢ, individually denoting the ONUs, is given traffic characteristics such as a reserved rate Rᵢ (a transfer rate allocated by the contract), an average rate Mᵢ, and a maximum or peak rate Pᵢ. The relationship between the traffic characteristics is given by the following expression.
Traffic Characteristics of ONUᵢ=[Rᵢ,Mᵢ,Pᵢ], where Mᵢ≦Rᵢ≦Pᵢ [Expression 1]

Since, in general, the average rate Mᵢ should be guaranteed to subscribers, the reserved rate Rᵢ has a value between the average rate Mᵢ and the peak rate Pᵢ as shown in Expression 1.

At step S100, a different number of tokens are generated for the ONUs according to their different transfer rates allocated to them based on the contract. The following expression shows a token generation rate Gᵢ with respect to the reserved rate Ri.

$${G}_{i} = \frac{{R}_{i}}{8} \qquad [ Expression 2 ]$$

Here, one token allows use of one-byte network service.

At step S100, a predetermined number of tokens for guaranteeing a minimum transfer rate for each ONU are separately stored. As a result, a predetermined number of tokens corresponding to the minimum guaranteed rate and a predetermined number of tokens corresponding to a transfer rate allocated to each ONU based on the contract are generated and stored at step S100. In other words, two different numbers (or two different kinds) of tokens are generated for each ONU at step S100. The above term “minimum guaranteed rate” refers to a transfer rate for traffic guaranteed to an ONU irrespective of the ONU's occupancy thereof.

In addition, the sum of transfer rates allocated to all ONUs is equal to a total bandwidth C as expressed in the following equation.

$$C = {\sum }_{i = 0}^{N} {R}_{i} \qquad [ Expression 3 ]$$

Here, “N” denotes the total number of ONUs, and “C” denotes a total transfer rate or bandwidth (for example, 1 Gbps) for downstream transmission.

The common token generated at step 200 thus has the same value as obtained by Expression 3. In other words, the common token generated at S200 has a value equal to the sum of values of all the individual tokens generated at step S100.

Such a generation of the individual tokens and the common token allows the EPON to complete preparation for transmitting downstream data. With the completion of downstream data transmission preparation, the EPON waits for the occurrence of downstream data that will be transmitted from a backbone network to the ONUs.

When downstream data occurs (S300), a downstream traffic control algorithm is employed to transmit the downstream data to its destination ONU (S400).

The downstream data transmission process of step S400 is illustrated in detail in FIG. 2b. As shown in this drawing, upon the occurrence of downstream data, the EPON classifies and stores the downstream data (S405). In general, downstream data to be transmitted to ONUs is multiplexed before transmission. At this step, after being demultiplexed, the downstream data is classified according to its destination ONU. Then, the classified downstream data is stored in a corresponding one of transmission buffers assigned respectively to the ONUs until it is determined whether the downstream data is transmittable according to the downstream traffic control algorithm.

This downstream traffic control algorithm is performed sequentially on a number of ONUs in a round robin scheme. For example, after checking whether downstream data is stored in each of the transmission buffers allocated respectively to the ONUs, the EPON performs the algorithm to determine whether the stored downstream data is transmittable.

Referring to FIG. 2b, the EPON initially selects a first ONU buffer (i.e., a transmission buffer corresponding to the first ONU) of the transmission buffers allocated respectively to the ONUs (S410), and checks whether there is downstream data awaiting transmission (for example, transmission data) stored in the first ONU buffer (S415).

IF there is no downstream data stored in the first-ONU buffer, an ONU buffer next to the currently selected buffer (i.e., the first ONU buffer) is selected without performing special processes on it (S455). If there is no next ONU buffer, the downstream data transmission process of step S400 is finished.

On the other hand, if the result of step S415 is that there is downstream data stored in the selected ONU buffer, it is determined whether or not the stored downstream data is transmittable, based on the number of previously stored tokens for the corresponding ONU (S420). In more detail, at this step, the volume of data stored in the ONU buffer is compared with the volume of data transmittable based on the number of previously stored tokens for the corresponding ONU. If the volume of data stored in the ONU buffer is smaller than or equal to the volume of data transmittable based on the number of previously stored tokens, it is determined that the downstream data is transmittable. Here, the number of tokens for the corresponding ONU has been generated and stored at step S100 as described above referring to FIG. 2a.

Based on the determination result of step S420, it is determined at step S425 that the downstream data stored in the selected ONU buffer is transmittable, the number of tokens allocated to the corresponding ONU is changed and the stored data is transmitted (S435). This token number change means that tokens as required for the downstream data transmission are deleted from the current tokens for the corresponding ONU. In other words, the number of tokens as required for the downstream data transmission is subtracted from the current number of tokens.

Based on the transmission result, a “service rate” corresponding to the corresponding ONU is then calculated (S450). A detailed method for calculating the service rate will be described with reference to FIG. 2c.

On the other hand, when, based on the determination result of step S420, it is determined at step S425 that the downstream data is not transmittable, it is determined whether the downstream data for the corresponding ONU is transmittable, based on the number of previously stored common tokens (S430). In detail, it is judged whether or not the number of previously stored common tokens is larger than or equal to a minimum guaranteed token number, and also whether or not the corresponding ONU's service rate for a predetermined period of time in the past meets a predetermined requirement. It is then determined that the downstream data can be transmitted by the common tokens, only when both the judgment results are affirmative. The determination as to whether the service rate of the corresponding ONU for the predetermined past period of time satisfies the predetermined requirement is performed, for example, based on the following inequality.

$$\frac{\begin{matrix}( contracted max . rate for {ONU}_{i} ) - \\ ( {ONU}_{i} ’ s service rate for predetermined past period )\end{matrix}}{ \begin{matrix}( contracted max . rate for {ONU}_{i} ) - \\ ( contracted average rate for {ONU}_{i} )\end{matrix}} \geq rand ( 0 , 1 ) \qquad [ Expression 4 ]$$

In this inequality, “ONUi” denotes the currently selected ONU. As can be seen from Expression 4, the left side value is calculated based on contracted maximum and average data rates for ONUᵢ, and further on a service rate given to ONUᵢ for a predetermined past period of time. Next, a random function is employed to generate a random value in the range of 0 to 1. When the generated random value is smaller than or equal to the calculated left-side value, it is determined that the common token is usable. If the service rate is smaller than or equal to the contracted average rate, the left-side value is greater than or equal to 1, so it is always determined that the common token is usable. On the contrary, if the service rate is higher than the contracted maximum rate, the left side value is smaller than or equal to 0, so the inequality of Expression 4 can never be satisfied. In addition, when the service rate falls between the contracted average and maximum rates, the number of cases satisfying the inequality of Expression 4 increases as the service rate is nearer to the contracted average rate.

Based on the determination result of step S430, it is determined at step S440 that the corresponding downstream data can be transmitted using the common token, the number of common tokens is changed and the downstream data is transmitted (S445). This token number change means that tokens as required for the downstream data transmission are deleted from common tokens. In other words, the number of tokens as required for the downstream data transmission is subtracted from the number of common tokens. The service rate of the corresponding ONU is then calculated based on the downstream data transmission result (S450).

It is then checked whether there is a next ONU buffer (S455). If this result is affirmative, the series of said steps S415 to S455 are repeated after a next ONU buffer is selected (S460).

FIG. 2c illustrates a method for measuring the service rate according to one embodiment of the present invention. In other words, the purpose of this drawing is to facilitate the explanation of the service rate calculation method of step S450. In FIG. 2c, a horizontal axis represents “time”, and each bar standing on a time section along the horizontal axis denotes a packet length serviced during the time section.

If a packet length serviced to ONUᵢ at a time of ‘k’ is defined as l(k), the service rate (aᵢ(t)) of ONUᵢ measured at a time of ‘t’ is defined by the following equation.

$${a}_{i} ( t ) = \frac{{\sum }_{j = t - 1}^{t} {l}_{i} ( j )}{T} \qquad [ Expression 5 ]$$

Here, “T” denotes a service-rate measurement unit time.

Such a service rate can be measured through a packet service rate meter provided on each buffer output. The reason for determining the service rate of downstream data for each ONU is as follows. That is, it is to judge the inequality of Expression 4 based on the determined service rate for each ONU, and then reduce the possibility of the ONU using the network service at the current time if it is judged it has received a large amount of services for a predetermined past time. In contrast, the possibility at the current time is increased if it is judged it has received a small amount of services for the predetermined past time.

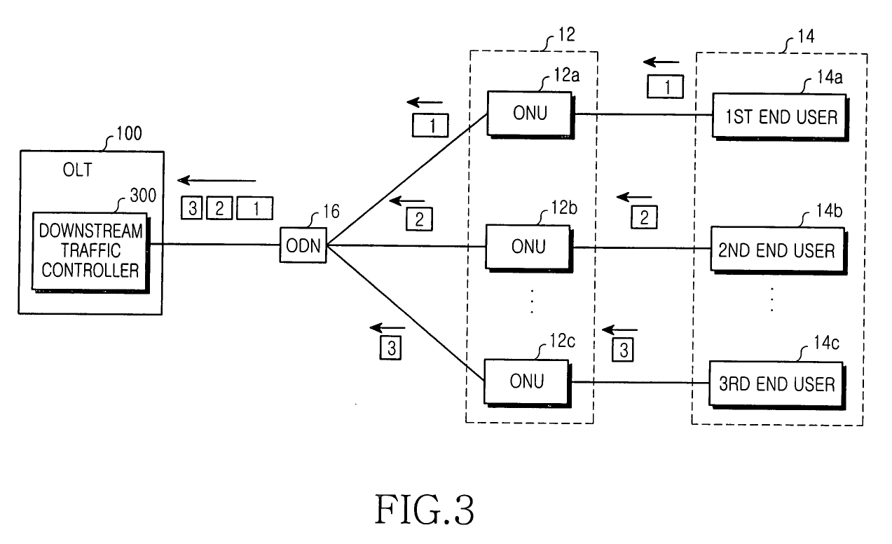

FIG. 3 is a block diagram showing an EPON according to one embodiment of the present invention. As shown in this figure, the EPON includes a downstream traffic controller 300 in the OLT 100 for controlling downstream traffic according to one embodiment of the present invention. The OLT 100 is connected to a backbone network through one of subscriber networks providing connections between a backbone network and subscribers. The OLT 100 is also connected to the ONUs 12a, 12b and 12c through an optical cable, and permits a passive element 16 called an “ODN” to distribute/transmit data to a number of the ONUs 12a to 12c. The downstream traffic controller 300 is a device to control the traffic of downstream data that will be transmitted from the OLT 100 to the ONUs 12a to 12c through the ODN 16. In FIG. 3, reference numeral “14”, not described above, denotes end users connected to the ONUs 12a to 12c.

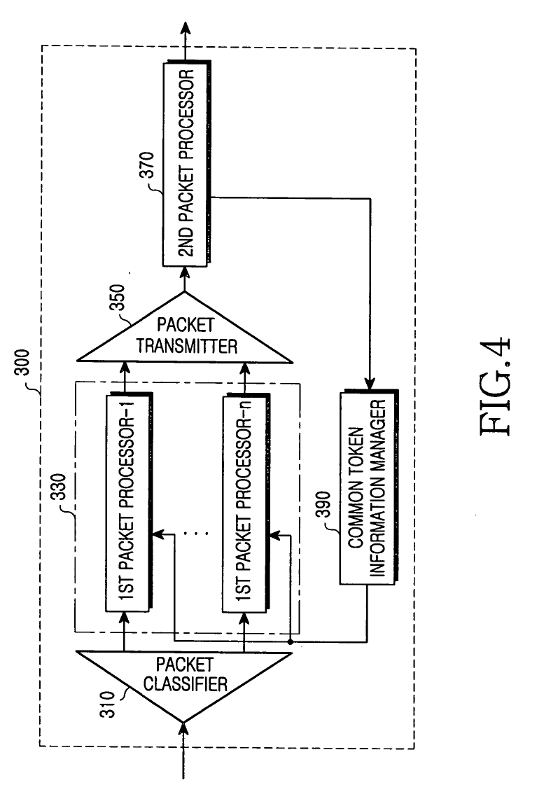

FIG. 4 is a block diagram schematically showing the downstream traffic controller 300 according to one embodiment of the present invention. As shown in this drawing, the downstream traffic controller 300 includes a packet classifier 310, a first packet processor 330, a packet transmitter 350, a second packet processor 370, and a common token information manager 390. The packet classifier 310 classifies downstream data (hereinafter, referred to as a “packet”) incoming from the backbone network according to its destination ONU, and transfers it to the first packet processor 330.

Upon receipt of the packet, the first packet processor 330, configured separately according to the ONUs as shown in FIG. 4, first stores it in a transmission buffer, and then determines whether the stored packet is transmittable. If it is determined that the stored packet is transmittable, it is transmitted to the packet transmitter 350.

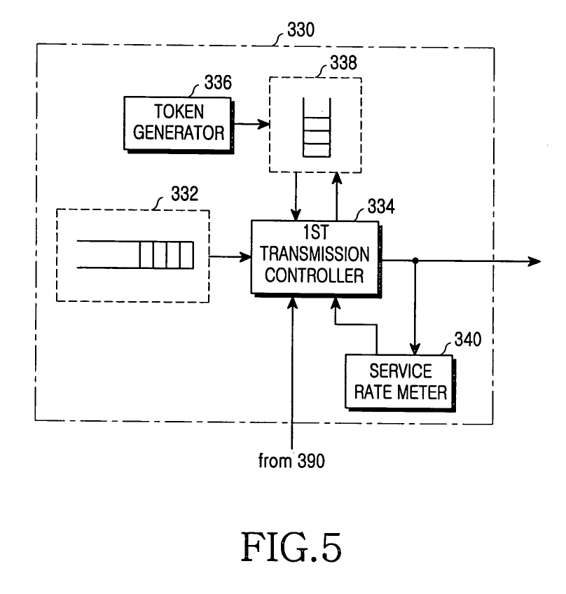

The first packet processor 330 performs the determination as to whether the stored packet is transmittable first by tokens allocated to the corresponding ONU, and then secondly by the common token if the first determination is negative. This packet transmission determination method will be described later in more detail referring to FIG. 5.

The packet transmitter 350 receives a packet to be transmitted to each ONU from the first packet processor 330, and converts it into an EPON frame. After attaching address information of the corresponding ONU to it, the packet transmitter 350 multiplexes and outputs the packet.

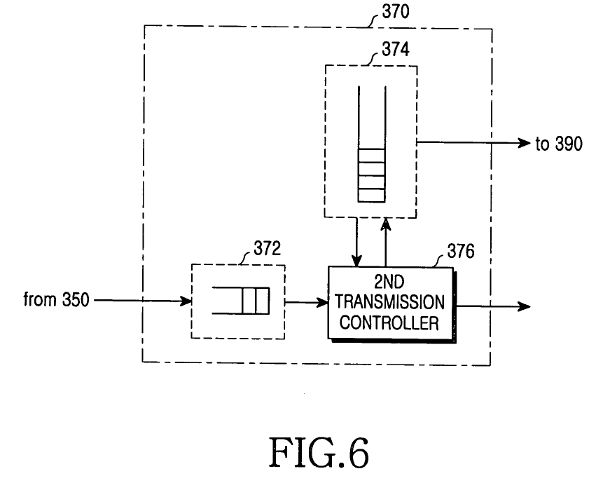

The second packet processor 370 temporarily stores the packet output from the packet transmitter 350, and then transmits it to its destination ONU through a downstream link. The second packet processor 370 discriminates a packet to be transmitted by the common token from packets received from the packet transmitter 350, and then changes the common token information and transmits the changed information to the common token information manager 390. Such a configuration and operation of the second packet processor 370 will be described in more detail referring to FIG. 6.

FIG. 5 is a schematic block diagram showing the first packet processor 330 according to one embodiment of the present invention. As shown in this drawing, the first packet processor 330 includes a transmission buffer 332, a first transmission controller 334, an individual token generator 336, an individual token storage 338 and a service rate meter 340. The transmission buffer 332 temporally stores a packet to be transmitted to the corresponding ONU.

The individual token generator 336 generates tokens according to a transfer rate allocated to the corresponding ONU based on the contract. In detail, the individual token generator 336 generates and stores a predetermined number of tokens corresponding to a transfer rate allocated to the corresponding ONU by the contract and a predetermined number of tokens corresponding to the minimum guaranteed rate. In other words, the individual token generator 336 generates two different numbers (or two different kinds) of tokens for each ONU. The term “minimum guaranteed rate” refers to a traffic guaranteed to an ONU irrespective of the ONU's occupancy thereof. The size of the generated tokens (for example, the volume of data transmittable using the tokens) is set equal to the product of the contracted maximum rate by a token generation time interval. The individual token storage 338 stores the tokens generated by the individual token generator 336.

The first transmission controller 334 determines whether the data stored in the transmission buffer 332 can be transmitted by the tokens allocated to the corresponding ONU. If it is determined that the stored data cannot be transmitted using the tokens allocated to the ONU, it is determined whether the data can be transmitted by the common token.

In order to determine whether the stored data can be transmitted by the tokens allocated to the corresponding ONU, the transmission controller 334 first compares the volume of the stored packet with the volume of data transmittable by the tokens allocated to the corresponding ONU. If the comparison result is that the stored packet volume is smaller than or equal to the data volume transmittable by the tokens allocated to the corresponding ONU, it is determined that the stored packet can be transmitted by the tokens allocated to the corresponding ONU. To this end, the first transmission controller 334 receives information of tokens allocated to the corresponding ONU from the individual token storage 338.

Further, in order to determine whether the stored packet can be transmitted by the common tokens, the first transmission controller 334 determines whether or not the number of previously stored common tokens is higher than or equal to a minimum guaranteed number token number, and also whether or not the corresponding ONU's service rate for a predetermined period of time in the past meets a predetermined requirement. If both the determination results are affirmative, it is determined that the stored packet can be transmitted by the common token. To this end, the first transmission controller 334 receives common token information from the common token information manager 390 that functions to store and manage the common token information.

If the above determination result is that the packet can be transmitted by common token or by tokens allocated individually to the ONUs, the packet is transmitted to the packet transmitter 350 shown in FIG. 4. In the case where it is determined that the packet can be transmitted by the tokens allocated individually to the ONUs, the packet transmission result is transferred to the individual token storage 338 so as to delete tokens corresponding to the transmitted packet volume from the individual token storage 338.

The service rate meter 340 measures a data rate (for example, a service rate) transmitted to the corresponding ONU for a predetermined period of time under the control of the first transmission controller 334. The service rate meter 340 measures the service rate in the same way as described above referring to FIG. 2c.

FIG. 6 is a schematic block diagram showing the second packet processor 370 according to one embodiment of the present invention. As shown in this figure, the second packet processor 3309 includes an integrated buffer 372, a common token storage 374, and a second transmission controller 376. The integrated buffer 372 stores packets that have been determined at the first packet processor 330 to be transmittable by the individual tokens and the common token and then transferred to the buffer 372 through the packet transmitter 350.

The common token storage 374 stores tokens allocated to the corresponding network (for example, an EPON). The tokens stored in the common token storage 374 are used for transmission of all the packets that are transmitted through the downstream link. Therefore, the tokens stored in the common token storage 374 correspond to the total sum of contracted rates for all the ONUs, and the size of the stored tokens is set equal to the downstream link capacity times the token generation time interval. The number of stored tokens in the common token storage 374 is changed by the packet transmission result, and the changed value is transferred to the common token information manager 390 shown in FIG. 4. The number of common tokens stored in this information manager 390 is referred to when the first packet processor 330 determines whether or not the packet is transmittable.

The second transmission controller 376 transmits the packets stored in the integrated buffer 372 to the ONU, and discriminates a packet to be transmitted by the common token from the packets, and then changes the number of common tokens stored in the common token storage 374 based on the packet transmission result.

As apparent from the above description, a method and apparatus for controlling downstream traffic in an EPON according to the present invention has the following advantages. Since downstream data is transmitted using individual tokens allocated to each ONU, based on individual rates contracted to each ONU, thereby guaranteeing individual bandwidths contracted to each ONU, it is possible to control the fairness among the ONUs. Thereby, it is also possible to monitor and control a bandwidth contracted for each ONU. Further, minimum/maximum data rates can be guaranteed to all ONUs that require downstream transmission, and QoS can be guaranteed against burst traffic in the EPON. Accordingly, it is possible to utilize network resources effectively in the EPON.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for controlling traffic of downstream data to be transmitted from an OLT (Optical Line Termination) to ONUs (Optical Network Units) in an EPON (Ethernet Passive Optical Network) including an ODN (Optical Distribution Network) connected to the OLT and a plurality of the ONUs connected to a plurality of subscribers, said method comprising the steps of:
a) generating individual tokens respectively for the ONUs based on individual transfer rates allocated respectively to the ONUs;
b), classifying the downstream data based on the data's destination ONU, and then storing the downstream data in transmission buffers which correspond respectively to the ONUs;
c) selecting one of the transmission buffers, and checking whether there is downstream data awaiting transmission stored in the selected buffer;
d) determining whether the downstream data can be transmitted based on individual token information, previously stored, for an ONU corresponding to the downstream data; and
e) calculating a service rate of the corresponding ONU according to the transmission result, and storing the calculated service rate.

2. The method as set forth in claim 1, wherein step a) further includes storing the individual tokens while classifying them according to the ONUs.

3. The method as set forth in claim 1, further includes the steps of:
f) generating a common token based on a total transfer rate of the EPON and then storing the common token;
g), if it is determined at the step d) that the downstream data cannot be transmitted based on the individual token information, determining whether the downstream data can be transmitted based on information of the common tokens;
h), if it is determined at the step g) that the downstream data can be transmitted based on the common token information, transmitting the downstream data, and changing the common token information according to the transmission result.

4. The method as set forth in claim 1, further comprising the step of:
i), if it is determined at the step d) that the downstream data can be transmitted based on the individual token information, transmitting the downstream data, and then calculating the service rate of the corresponding ONU after changing the individual token information of the corresponding ONU according to the transmission result.

5. The method as set forth in claim 4, wherein all the transmission buffers corresponding respectively to the ONUs connected to the EPON are selected one by one in a round robin scheme.

6. The method as set forth in claim 3, wherein, at the step b), the common token is generated to have the same value as a sum of all the individual tokens generated at the step a).

7. The method as set forth in claim 1, wherein the step e) includes the steps of:
e-1) comparing a volume of data stored in each of the transmission buffers with a volume of data transmittable by an individual token for a corresponding one of the ONUs; and
e-2) determining that said data stored in each of the transmission buffers can be transmitted, if the compared result of the step e-1) is that said volume of data stored in each of the transmission buffers is smaller than or equal to said volume of data transmittable by the individual token.

8. The method as set forth in claim 3, wherein the step f) includes the steps of:
f-1) determining whether the number of common tokens is larger than or equal to a minimum guaranteed token number, and whether a service rate of the corresponding ONU for a predetermined past period of time satisfies a predetermined condition; and
f-2), if it is determined at the step f-1) that the number of common tokens is larger than or equal to the minimum guaranteed token number and the service rate of the corresponding ONU for the predetermined past period of time also satisfies a condition expressed by the following inequality, determining that the corresponding downstream data can be transmitted by the common token:
$$\frac{\begin{matrix}( contracted max . rate for {ONU}_{i} ) - \\ ( {ONU}_{i} ’ s service rate for predetermined past period )\end{matrix}}{ \begin{matrix}( contracted max . rate for {ONU}_{i} ) - \\ ( contracted average rate for {ONU}_{i} )\end{matrix}} \geq rand ( 0 , 1 )$$
where “ONUᵢ” denotes the corresponding ONU.

9. The method as set forth in claim 1, wherein, at the step h), an average length of downstream data serviced to each of the ONUs for a predetermined period of time is calculated as a downstream data service rate of said each of the ONUs.

10. The method as set forth in claim 4, wherein, at the step i), an average length of downstream data serviced to each of the ONUs for a predetermined period of time is calculated as a downstream data service rate of said each of the ONUs.

11. An apparatus for controlling traffic of downstream data to be transmitted from an OLT (Optical Line Termination) to ONUs (Optical Network Units) in an EPON (Ethernet Passive Optical Network) including an ODN (Optical Distribution Network) connected to the OLT and a plurality of the ONUs connected to a plurality of subscribers, said apparatus comprising:
a packet classifier for classifying downstream data according to its destination ONU;
a first packet processor for determining whether downstream data can be transmitted based on the individual token information previously stored for an ONU corresponding to the downstream data;
a packet transmitter for receiving downstream data to be transmitted to each of the ONUs from the first packet processor, and converting the downstream data into an EPON frame, and then multiplexing and outputting the downstream data after attaching address information of the corresponding ONU; and
a second packet processor for temporarily storing a downstream data signal output from the packet transmitter, and transmitting the downstream data signal to a corresponding ONU through a downstream link connected to the corresponding ONU.

12. The apparatus as set forth in claim 11, further comprising:
a common token information manager for managing common token information according to a total transfer rate of the EPON; and
the first packet processor further determining whether downstream data can be transmitted based on common token information.

13. The apparatus as set forth in claim 12, wherein the second packet processor further changes the common token information based on the transmission result and transfers the changed result to the common token information manager.

14. The apparatus as set forth in claim 11, wherein the first packet processor includes:
an individual token generator for generating an individual token for a corresponding ONU according to a transfer rate that has been allocated to the corresponding ONU based on an established contract;
an individual token storage for storing the individual token for the corresponding ONU generated by the individual token generator;
a transmission buffer for temporarily storing downstream data to be transmitted to the corresponding ONU;
a first transmission controller for determining whether the downstream data can be transmitted based on individual token information of the corresponding ONU, and, if this determination result is negative, determining whether the downstream data can be transmitted based on common token information; and
a service rate meter for measuring a data transfer rate or a service rate of a corresponding ONU for a predetermined period of time under control of the first transmission controller.

15. The apparatus as set forth in claim 14, wherein the individual token generator generates a predetermined number of tokens corresponding to a transfer rate allocated to the corresponding ONU, and a predetermined number of tokens corresponding to a minimum guaranteed transfer rate.

16. The apparatus as set forth in claim 14, wherein the first transmission controller compares a volume of downstream data stored in the transmission buffer with a volume of data transmittable by the individual token information, and determines that the downstream data can be transmitted by the individual token information, if the compared result is that said volume of downstream data stored in the transmission buffer is smaller than or equal to said volume of data transmittable by the individual token information.

17. The apparatus as set forth in claim 14, wherein the first transmission controller receives the common token information from the common token information manager, and determines whether the number of common tokens previously stored is larger than or equal to a minimum guaranteed token number, and whether a service rate of the corresponding ONU for a predetermined past period of time satisfies a condition expressed by the following inequality, and then, if it is determined that said number of common tokens previously stored is larger than or equal to the minimum guaranteed token number and the service rate also satisfies the condition expressed by the following inequality, determines that the downstream data can be transmitted by the common token:
$$\frac{\begin{matrix}( contracted max . rate for {ONU}_{i} ) - \\ ( {ONU}_{i} ’ s service rate for predetermined past period )\end{matrix}}{ \begin{matrix}( contracted max . rate for {ONU}_{i} ) - \\ ( contracted average rate for {ONU}_{i} )\end{matrix}} \geq rand ( 0 , 1 )$$
where “ONUᵢ” denotes the corresponding ONU.

18. The apparatus as set forth in claim 14, wherein the first transmission controller changes the individual token information stored in the individual token storage, based on the result of the downstream data transmission by the individual token information.

19. The apparatus as set forth in claim 14, wherein an average length of downstream data serviced to each of the ONUs for a predetermined period of time is calculated, by the service rate meter, as a downstream data service rate of said each of the ONUs.

20. The apparatus as set forth in claim 12, wherein the second packet processor includes:
an integrated buffer for storing downstream data that has been determined at the first packet processor to be transmittable by the individual token information and the common token information and then transferred to the integrated buffer through the packet transmitter;
a common token storage for storing the common token information as token information corresponding to a transfer rate allocated to the EPON; and
a second transmission controller for transmitting the downstream data stored in the integrated buffer to a corresponding ONU, and changing the common token information stored in the common token storage based on the transmission result.
